(19) United States
(12) Patent Application Publication
(10) Pub. No.: US 2015/0169574 A1
(43) Pub. Date: Jun. 18, 2015

(54) PROCESSING OF FRESH-SEEKING SEARCH QUERIES

(71) Applicants: David BAU, Lincoln, MA (US); Ankur BHARGAVA, Cambridge, MA (US)

(72) Inventors: David BAU, Lincoln, MA (US); Ankur BHARGAVA, Cambridge, MA (US)

(73) Assignee: GOOGLE INC., Mountain View, CA (US)

(21) Appl. No.: 13/277,596

(22) Filed: Oct. 20, 2011

(51) Int. Cl. G06F 17/30

(52) U.S. Cl. CPC G06F 17/3053; G06F 17/30551

(57) ABSTRACT

In one implementation, a device may identify documents that are associated with a timestamp. The device may sort the documents, based on the timestamps, create a timeline of documents; and may determine a best-fit step function to fit the timeline of documents. The device may identify at least one event, associated with the timeline of documents, based on the best-fit step function. The device may modify relevance scores associated with the documents based on the identified at least one event.

### BACKGROUND

Many techniques are available to users today to find information on the world wide web (“web”). For example, users often use web browsers and/or search engines to find information of interest.

One type of commonly performed search is an image search, in which, in response to a search query, images are returned that are relevant to the search query. Relevancy may be determined by, for example, matching terms in the search query to terms obtained from the file names of the images, descriptive information in the web pages that include the images, labels or tags associated with the images, or from other sources.

Some image search queries may be static if the timeliness of the images is not necessary to consider when determining the responsiveness of the images to the image search queries. For example, the search query for “flower” is likely to be a search query in which the user may not necessarily prefer recent images over older images. However, the search query “miss universe pageant” may be a search query in which the user desires to view images of more recent winners of the Miss Universe Pageant.

### SUMMARY

One possible implementation may be directed to a method that includes receiving a search query; identify documents, relevant to the search, where each of the documents is associated with a timestamp and a relevance score; sorting the documents, based on the timestamps, to create a timeline of documents; and determining a best-fit step function to fit the timeline of documents. The method may include identifying at least one event, associated with the timeline of documents, based on the best-fit step function; modifying the relevance scores of the documents, based on the at least one identified event; and transmitting, information associated with a portion of the documents, based on the modified relevance scores, to the client.

Another possible implementation may be directed to a computer-readable medium that includes one or more instructions, which when executed by one or more processors, cause the one or more processors to receive, from a client, a search query; one or more instructions, which when executed by one or more processors, cause the one or more processors to identify documents, relevant to the search query, where each of the documents is associated with a timestamp and a relevance score; one or more instructions, which when executed by one or more processors, cause the one or more processors to sort the documents, based on the timestamps, to create a timeline of documents; one or more instructions, which when executed by one or more processors, cause the one or more processors to determine a best-fit step function to fit the timeline of documents; one or more instructions, which when executed by one or more processors, cause the one or more processors to identify at least one event, associated with the timeline of documents, based on the best-fit step function; one or more instructions, which when executed by one or more processors, cause the one or more processors to transmit information associated with a portion of the plurality of documents, based on the modified relevance scores, to the client.

In another possible implementation, a computing device may include a memory to store instructions and one or more processors, to execute the instructions. The instructions, when executed, may: receive, from a client, a search query; identify a plurality of documents, relevant to the search query, where each of the plurality of documents is associated with a timestamp and a relevance score; sort the plurality of documents, based on the timestamps, to create a timeline of documents; determine a best-fit step function to fit the timeline of documents; identify at least one event, associated with the timeline of documents, based on the best-fit step function; modify the relevance scores of the plurality of documents, based on the identified at least one event; and transmit information associated with a portion of the plurality of documents, based on the modified relevance scores, to the client.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 is a diagram illustrating an example of a fresh-seeking query;

FIG. 2 is a diagram of an example environment in which techniques described herein may be implemented;

FIG. 3 shows an example of a generic computing device and a generic mobile computing device;

FIG. 4 is a diagram of example functional components relating to search query freshness detection;

FIG. 5 is a flow chart of an example process for the operation of the analysis component shown in FIG. 4;

FIG. 6 is a diagram illustrating an example of an initial set of documents;

FIG. 7 is a diagram illustrating an example histogram;

FIG. 8 is a diagram illustrating an example of a monotonically increasing step function;

FIG. 9 is a flow chart of an example process illustrating the operation of the relevance score modification component shown in FIG. 4; and

FIG. 10 is a diagram illustrating an example of the set of documents, as shown in FIG. 6, and further including an example of modified versions of the relevance scores.

### DETAILED DESCRIPTION

The following detailed description refers to the accompanying drawings. The same reference numbers in different drawings may identify the same or similar elements.

### Overview

A set of documents, in which each document is associated with a timestamp, may be analyzed to determine whether events occurred in a timeline constructed based on the timestamps associated with the documents. A surge in the quantity of documents corresponding to a particular topic existing on the Internet may occur after points in time corresponding to an event. For example, images crawled from the Internet, about a popular fictional character, may experience an increase in the quantity of posted images when a new book or movie, about the character, is released. A search query, such as an image search query for the fictional character, may be a fresh-seeking search query in the sense that the user that submitted the search query is likely to be looking for images related to a recent event, e.g., the user may be looking for images of the fictional character in the context of the new book or movie.

As described herein, documents relating to a search query, such as images returned based on an image search query, may be analyzed to determine whether the search query is a fresh-seeking search query. If the search query is determined to be a fresh-seeking search query, the relevance of the documents initially returned by the search engine may be modified to favor images that were created, generated, or posted in response to the occurrence of an event that caused the search query to be fresh-seeking.

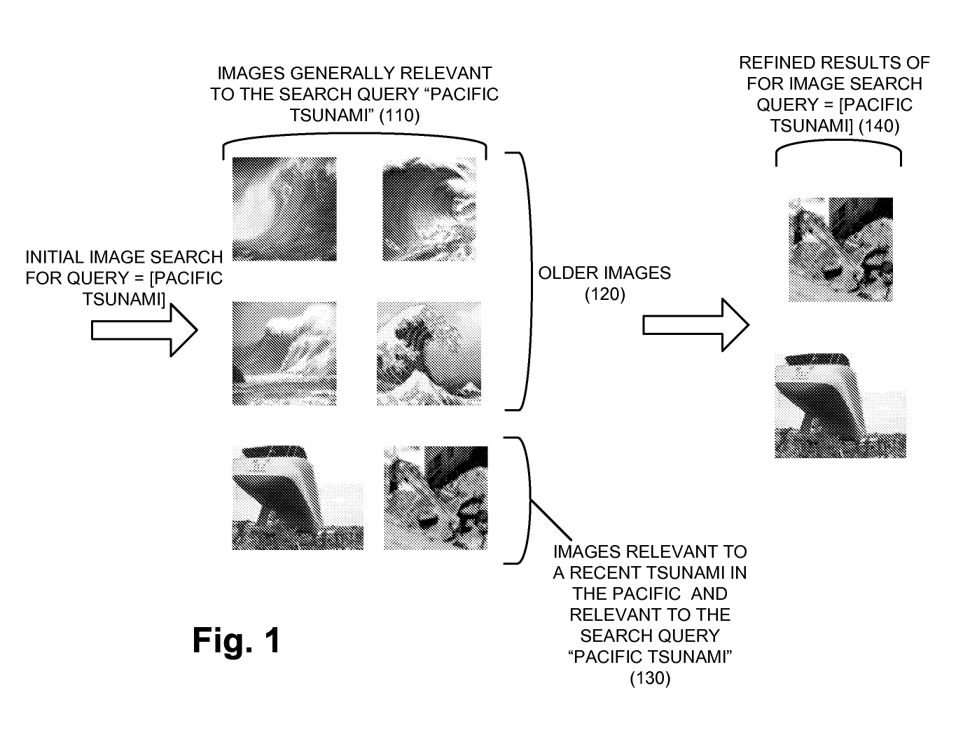

FIG. 1 is a diagram illustrating an example of a fresh-seeking search query. Assume that a user desires to find images related to the topic “pacific tsunami.” The user may submit this query to an image search engine. Using conventional search techniques, the image search engine may initially identify a set of images 110 that are related to this search query. Set of images 110 may include images that are associated with a wide range of dates. For example, some of these images may be general images of a tsunami wave, which may be generally time insensitive. Others of the images may be images of damage caused by a specific tsunami. These images may include time-relevant images that correspond to a particular event, e.g., a tsunami. Very new images may describe an old event, but it is impossible for an old image to describe a newer event.

For the set of images 110, images 120 may be older images and images 130 may be newer images that were taken of a particular event, e.g., a tsunami that occurred in the Pacific. Consistent with aspects described herein, a server may identify the images that are associated with discrete events. Based on this, the server may classify the search query as a fresh-seeking query. The server may then refine the relevance ranking of each of the images in the set of images 110 to enforce a preference for the images that are taken after the occurrence of an event. As shown, images 140, which may be the images provided to the user, may preferentially include newer images 130, as the response to the search query. In this way, image search queries that are determined to be queries that are likely seeking newer (fresh) results, may be identified and used to enhance the results returned for the search query.

The concepts described herein may be applied to sets of documents. In one implementation, the documents may be images, such as images indexed by an image search engine. More generally, a document may be broadly interpreted to include any machine-readable and machine-storable work product. A document may include, for example, an e-mail, a web site, a file, a combination of files, one or more files with embedded links to other files, a news group posting, a news article, a blog, a business listing, an electronic version of printed text, a web advertisement, etc. In the context of the Internet, a common document is a web page. Documents often include textual information and may include embedded information, such as meta information, images, hyperlinks, etc., and/or embedded instructions, such as Javascript, etc. A “link,” as the term is used herein, is to be broadly interpreted to include any reference to/from a document from/to another document or another part of the same document.

A “timeline of documents” or a “timeline of images,” as used herein, may refer to a construction of the documents, or images, in which timestamps associated with the documents or images are used to arrange the documents or images, or references to the documents or images, in a representation sorted with respect to the timestamps. In one implementation, a histogram may be used to implement the timeline of documents or images.

In the description herein, a device may be described as performing operations with respect to a document or a set of documents. This description may be broadly interpreted to include the device performing operations with respect to a link to a document, an identifier associated with the document, or a set of links to documents or a set of identifiers associated with the documents. For example, although a search component may be described as identifying and/or processing documents, in response to a search query, the search component may, in practice, identify/process links or references to the documents.

### System Overview

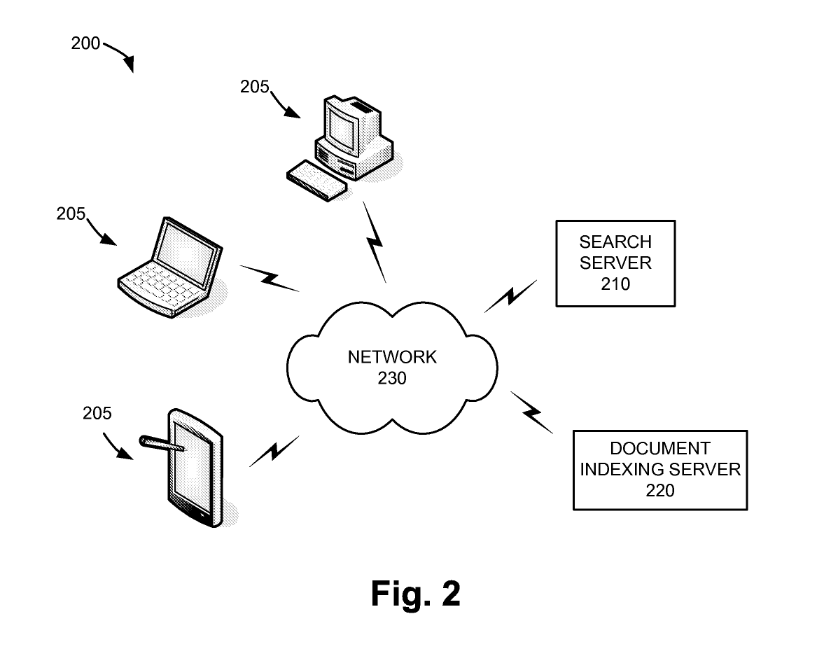

FIG. 2 is a diagram of an example environment 200 in which techniques described herein may be implemented. Environment 200 may include multiple clients 205 connected to one or more servers 210-220 via a network 230. In one implementation, and as illustrated, server 210 may be a search server, such as a search engine, and server 220 may be a document indexing server, e.g., a web crawler. Clients 205 and servers 210-220 may connect to network 230 via wired, wireless, or a combination of wired and wireless connections.

Three clients 205 and two servers 210-220 are illustrated as connected to network 230 for simplicity. In practice, there may be additional or fewer clients and servers. Also, in some instances, a client may perform one or more functions of a server and a server may perform one or more functions of a client.

Clients 205 may include devices of users that access servers 210-220. A client 205 may include, for instance, a personal computer, a wireless telephone, a personal digital assistant (PDA), a laptop, a smart phone, a tablet computer, or another type of computation or communication device. Servers 210-220 may include devices that access, fetch, aggregate, process, search, provide, and/or maintain documents. Although shown as single components 210 and 220 in FIG. 2, each server 210 and 220 may, in some implementations, be implemented as multiple computing devices, which potentially may be geographically distributed.

Search server 210 may include one or more computing devices designed to implement a search engine, such as an image search engine, general web page search engine, etc. Search server 210 may, for example, include one or more web servers to receive search queries from clients 205, search one or more databases in response to the search queries, and return documents, relevant to the search queries, to clients 205. In one implementation, search server 210 may include an image search server.

Document indexing server 220 may include one or more computing devices designed to index documents available through network 230. Document indexing server 220 may access other servers, such as web servers that host content, to index the content. In one implementation, document indexing server 220 may index images stored by other servers connected to network 230. Document indexing server 220 may, for example, locate images stored at other servers and index text that describes the images, such as text obtained from the filename of the image, text obtained from the webpage at which the image is hosted, or text obtained from metadata that is part of the image file. Document indexing server 220 may create a document index that stores information associated with the documents. Document indexing server 220 may also associate, within the document index, a date with each indexed document. Document indexing server 220 may provide its document index to search server 210, for use by search server 210 when handling search queries.

The date, associated with a document, will be referred to herein as a timestamp. In the context of an image, the timestamp may correspond to, for example, one or more of: the date the image is first indexed by document indexing server 220, the date a web page that contains the image is first indexed by document indexing server 220, the date associated with another duplicate image that was previously indexed by document indexing server 220, a date obtained from the filename associated with the image, a date obtained from metadata associated with the image, a date obtained from text surrounding or describing the image, or a date, obtained in some other manner, that is associated with the image.

While servers 210-220 are shown as separate entities, it may be possible for one of servers 210-220 to perform one or more of the functions of the other one of servers 210-220. For example, it may be possible that servers 210 and 220 are implemented as a single server. It may also be possible for a single one of servers 210 and 220 to be implemented as two or more separate, and possibly distributed, devices.

Network 230 may include one or more networks of any type, such as a local area network (LAN), a wide area network (WAN), a metropolitan area network (MAN), a telephone network, such as the Public Switched Telephone Network (PSTN) or a Public Land Mobile Network (PLMN), an intranet, the Internet, a memory device, or a combination of networks.

Although FIG. 2 shows example components of environment 200, in other implementations, environment 200 may contain fewer components, different components, differently arranged components, and/or additional components than those depicted in FIG. 2. Alternatively, or additionally, one or more components of environment 200 may perform one or more other tasks described as being performed by one or more other components of environment 200.

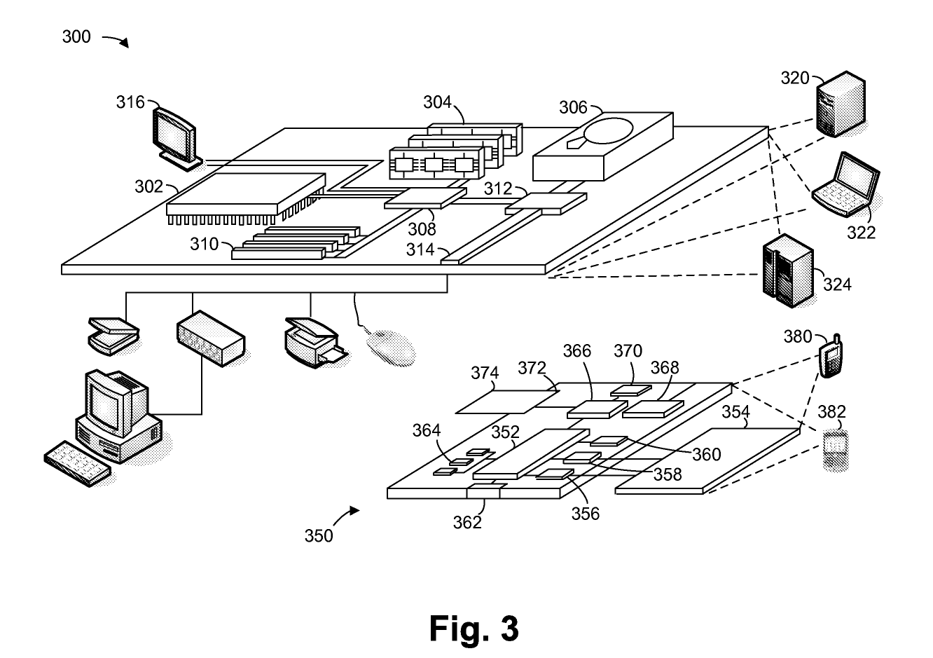

FIG. 3 shows an example of a generic computing device 300 and a generic mobile computing device 350, which may be used with the techniques described herein. Computing device 300 may correspond to, for example, client 205 and/or server 210/220. For example, each of clients 205 and servers 210/220 may include one or more computing devices 300. Mobile computing device 350 may correspond to, for example, portable implementations of clients 205.

Computing device 300 is intended to represent various forms of digital computers, such as laptops, desktops, workstations, personal digital assistants, servers, blade servers, mainframes, and other appropriate computers. Mobile computing device 350 is intended to represent various forms of mobile devices, such as personal digital assistants, cellular telephones, smart phones, and other similar computing devices. The components shown here, their connections and relationships, and their functions, are meant to be examples only, and are not meant to limit implementations described and/or claimed in this document.

Computing device 300 may include a processor 302, memory 304, a storage device 306, a high-speed interface 308 connecting to memory 304 and high-speed expansion ports 310, and a low speed interface 312 connecting to low speed bus 314 and storage device 306. Each of the components 302, 304, 306, 308, 310, and 312, may be interconnected using various busses, and may be mounted on a common motherboard or in other manners as appropriate. Processor 302 may process instructions for execution within computing device 300, including instructions stored in the memory 304 or on storage device 306 to display graphical information for a graphical user interface (GUI) on an external input/output device, such as display 316 coupled to high speed interface 308. In another implementation, multiple processors and/or multiple buses may be used, as appropriate, along with multiple memories and types of memory. Also, multiple computing devices 300 may be connected, with each device providing portions of the necessary operations, e.g., as a server bank, a group of blade servers, or a multi-processor system, etc.

Memory 304 may store information within computing device 300. In one implementation, memory 304 may include a volatile memory unit or units. In another implementation, memory 304 may include a non-volatile memory unit or units. Memory 304 may also be another form of computer-readable medium, such as a magnetic or optical disk. A computer-readable medium may be defined as a non-transitory memory device. A memory device may include memory space within a single physical memory device or spread across multiple physical memory devices.

Storage device 306 may provide mass storage for computing device 300. In one implementation, storage device 306 may include a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described below. The information carrier may include a computer or machine-readable medium, such as memory 304, storage device 306, or memory included within processor 302.

High speed controller 308 may manage bandwidth-intensive operations for computing device 300, while low speed controller 312 may manage lower bandwidth-intensive operations. Such allocation of functions is an example only. In one implementation, high-speed controller 308 may be coupled to memory 304, display 316, e.g., through a graphics processor or accelerator, and to high-speed expansion ports 310, which may accept various expansion cards (not shown). In the implementation, low-speed controller 312 may be coupled to storage device 306 and to low-speed expansion port 314. Low-speed expansion port 314, which may include various communication ports, e.g., USB, Bluetooth, Ethernet, wireless Ethernet, may be coupled to one or more input/output devices, such as a keyboard, a pointing device, a scanner, or a networking device, such as a switch or router, e.g., through a network adapter.

Computing device 300 may be implemented in a number of different forms, as shown in FIG. 3. For example, it may be implemented as a standard server 320, or multiple times in a group of such servers. It may also be implemented as part of a rack server system 324. Additionally or alternatively, computing device 300 may be implemented in a personal computer, such as a laptop computer 322. Additionally or alternatively, components from computing device 300 may be combined with other components in a mobile device (not shown), such as mobile computing device 350. Each of such devices may contain one or more of computing device 300, mobile computing device 350, and/or an entire system may be made up of multiple computing devices 300 and/or mobile computing devices 350 communicating with each other.

Mobile computing device 350 may include a processor 352, a memory 364, an input/output (I/O) device such as a display 354, a communication interface 366, and a transceiver 368, among other components. Mobile computing device 350 may also be provided with a storage device, such as a micro-drive or other device (not shown), to provide additional storage. Each of components 350, 352, 364, 354, 366, and 368, may be interconnected using various buses, and several of the components may be mounted on a common motherboard or in other manners as appropriate.

Processor 352 may execute instructions within mobile computing device 350, including instructions stored in memory 364. Processor 352 may be implemented as a set of chips that may include separate and multiple analog and/or digital processors. Processor 352 may provide, for example, for coordination of the other components of mobile computing device 350, such as, for example, control of user interfaces, applications run by mobile computing device 350, and/or wireless communication by mobile computing device 350.

Processor 352 may communicate with a user through control interface 358 and a display interface 356 coupled to a display 354. Display 354 may include, for example, a TFT LCD (Thin-Film-Transistor Liquid Crystal Display), an OLED (Organic Light Emitting Diode) display, and/or other appropriate display technology. Display interface 356 may comprise appropriate circuitry for driving display 354 to present graphical and other information to a user. Control interface 358 may receive commands from a user and convert them for submission to processor 352. In addition, an external interface 362 may be in communication with processor 352, so as to enable near area communication of mobile computing device 350 with other devices. External interface 362 may provide, for example, for wired communication in some implementations, or for wireless communication in other implementations, and multiple interfaces may also be used.

Memory 364 may store information within mobile computing device 350. Memory 364 can be implemented as one or more of a computer-readable medium or media, a volatile memory unit or units, or a non-volatile memory unit or units. Expansion memory 374 may also be provided and connected to mobile communication device 350 through expansion interface 372, which may include, for example, a Single In Line Memory Module (SIMM) card interface. Such expansion memory 374 may provide extra storage space for mobile computing device 350, or may also store applications or other information for mobile computing device 350. Specifically, expansion memory 374 may include instructions to carry out or supplement the processes described above, and may also include secure information. Thus, for example, expansion memory 374 may be provided as a security module for mobile computing device 350, and may be programmed with instructions that permit secure use of mobile computing device 350. In addition, secure applications may be provided via SIMM cards, along with additional information, such as placing identifying information on a SIMM card in a non-hackable manner.

Memory 364 and/or expansion memory 374 may include, for example, flash memory and/or NVRAM memory, as discussed below. In one implementation, a computer program product may be tangibly embodied in an information carrier. The computer program product may store instructions that, when executed, perform one or more methods, such as those described above. The information carrier may correspond to a computer- or machine-readable medium, such as the memory 364, expansion memory 374, or memory included within processor 352, that may be received, for example, over transceiver 368 or over external interface 362.

Mobile computing device 350 may communicate wirelessly through a communication interface 366, which may include digital signal processing circuitry where necessary. Communication interface 366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 368. In addition, short-range communication may occur, such as using a Bluetooth, WiFi, or other such transceiver (not shown). In addition, a Global Positioning System (GPS) receiver module 370 may provide additional navigation- and location-related wireless data to mobile computing device 350, which may be used as appropriate by applications running on mobile computing device 350.

Mobile computing device 350 may also communicate audibly using an audio codec 360, which may receive spoken information from a user and convert it to usable digital information. Audio codec 360 may likewise generate audible sound for a user, such as through a speaker, e.g., in a handset of mobile computing device 350. Such sound may include sound from voice telephone calls, may include recorded sound, e.g., voice messages, music files, etc., and may also include sound generated by applications operating on mobile computing device 350.

Mobile computing device 350 may be implemented in a number of different forms, as shown in FIG. 3. For example, it may be implemented as a cellular telephone 380. It may also be implemented as part of a smart phone 382, a personal digital assistant (not shown), and/or other similar mobile device.

Various implementations of the systems and techniques described herein may be realized in digital electronic circuitry, integrated circuitry, specially designed application specific integrated circuits (ASICs), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, may include machine instructions for a programmable processor, and may be implemented in a high-level procedural and/or object-oriented programming language, and/or in assembly/machine language. As used herein, the terms “machine-readable medium” and “computer-readable medium” may refer to any computer program product, apparatus and/or device, e.g., magnetic discs, optical disks, memory, Programmable Logic Devices (PLDs), used to provide machine instructions and/or data to a programmable processor, including a machine-readable medium that receives machine instructions as a machine-readable signal. The term “machine-readable signal” may refer to any signal used to provide machine instructions and/or data to a programmable processor.

To provide for interaction with a user, the systems and techniques described herein may be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

The systems and techniques described herein may be implemented in a computing system that includes a back end component, e.g., as a data server, or that includes a middleware component, e.g., an application server, or that includes a front end component, e.g., a client computer having a graphical user interface or a Web browser through which a user can interact with an implementation of the systems and techniques described here, or any combination of such back end, middleware, or front end components. The components of the systems may be interconnected by any form or medium of digital data communication, e.g., a communication network. Examples of communication networks include a local area network (“LAN”), a wide area network (“WAN”), and the Internet.

Although FIG. 3 shows example components of computing device 300 and mobile computing device 350, computing device 300 or mobile computing device 350 may include fewer components, different components, additional components, or differently arranged components than depicted in FIG. 3. Additionally or alternatively, one or more components of computing device 300 or mobile computing device 350 may perform one or more tasks described as being performed by one or more other components of computing device 300 or mobile computing device 350.

### Fresh-Seeking Query Processing

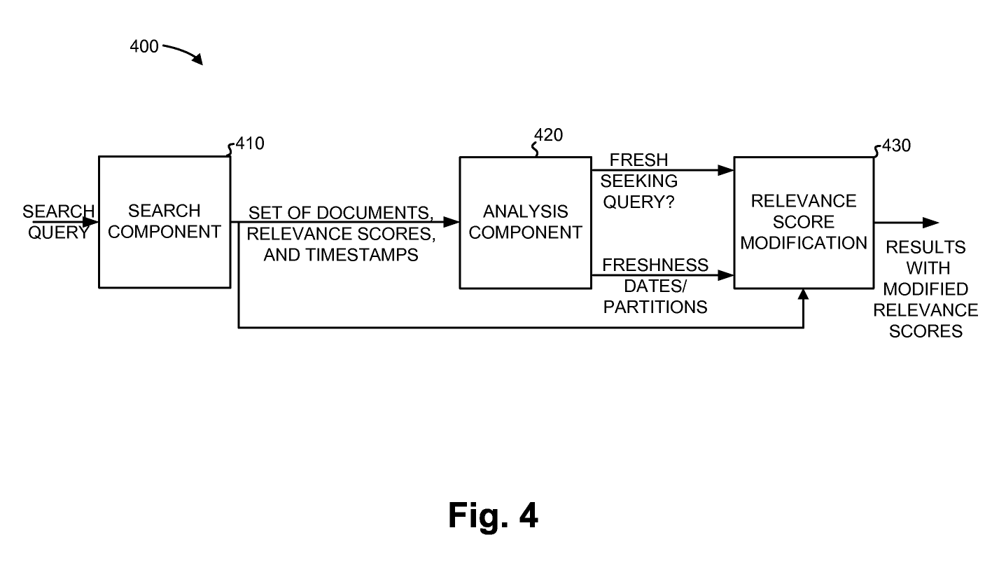

FIG. 4 is a diagram of example functional components 400 relating to search query freshness detection. Functional components 400 may be implemented by a server, such as search server 210. Functional components 400 may perform three general operations: (1) determine whether a search query is seeking fresh documents, i.e., is the search query a fresh-seeking query; (2) for a fresh-seeking query, partition a set of documents, relevant to the search query, into time-based sections (called epochs herein) that may be associated with one or more events; and (3) modify initial relevance scores of the set of documents based on the corresponding epochs associated with the set of documents.

As shown in FIG. 4, functional components 400 may include a search component 410, an analysis component 420, and a relevance score modification component 430.

Search component 410 may receive a search query from a client 205. Search component 410 may use the search query to identify a set of documents. For example, search component 410 may analyze search terms, of the search query, against terms in a document index to identify documents that include those search terms. For each identified document, search component 410 may generate a relevance score, which reflects a measure of relevance of the identified document to the search query. Many different techniques exist for measuring the relevance of a document to a search query.

For each of the identified documents, search component 410 may obtain a timestamp associated with the identified document. In one implementation, search component 410 may obtain the timestamp from the document index. In another implementation, search component 410 may obtain the timestamp from a memory that stores timestamps in association with documents. The timestamp may define a date associated with the document. As described previously, in the context of an image, the timestamp may define: the date that the image is first indexed by document indexing server 220, the date that a web page that contains the image is first indexed by document indexing server 220, the date associated with another duplicate image that was previously indexed by document indexing server 220, a date obtained from the filename associated with the image, a date obtained from metadata associated with the image, a date obtained from text surrounding or describing the image, or a date, obtained in some other manner, that is associated with the image.

Analysis component 420 may receive the set of documents, relevance scores, and timestamps from search component 410. Analysis component 420 may generally operate to determine a best-fit step function for the set of documents that are arranged based on the timestamps. For instance, as described in more detail below, the set of documents, based on the timestamps, may be sorted and binned into a histogram. A monotonic increasing step function may be fit to the histogram, as a best-fit step function. Analysis component 420 may use the step function to determine whether the search query is a fresh-seeking search query. Analysis component 420 may also use the step function to partition the histogram into sections that relate to events that may have occurred and/or that provide one or more dates that may define periods in which documents, associated with timestamps from different periods, may have their relevance rankings adjusted differently, e.g., documents after a particular date may have their relevance rankings boosted.

Relevance score modification component 430 may modify the initial relevance scores, received from search component 410, based on the output of analysis component 420. For instance, in one implementation, if the search query is determined to be a fresh-seeking query, documents, such as images, that are associated with a timestamp before a particular date, as determined by analysis component 420, may have their relevance scores reduced, or alternatively, documents associated with a timestamp after a particular date may have their relevance scores increased. Relevance score modification component 430 may reorder the set of documents, based on the modified relevance scores, to emphasize documents with higher relevance scores.

The operation of analysis component 420 and relevance score modification component 430 will be described in more detail below.

Although FIG. 4 shows an example of functional components 400, in other implementations, functional components 400 may contain fewer components, different components, differently arranged components, and/or additional components than those depicted in FIG. 4. Alternatively, or additionally, one or more functional components 400 may perform one or more other tasks described as being performed by one or more other functional components 400.

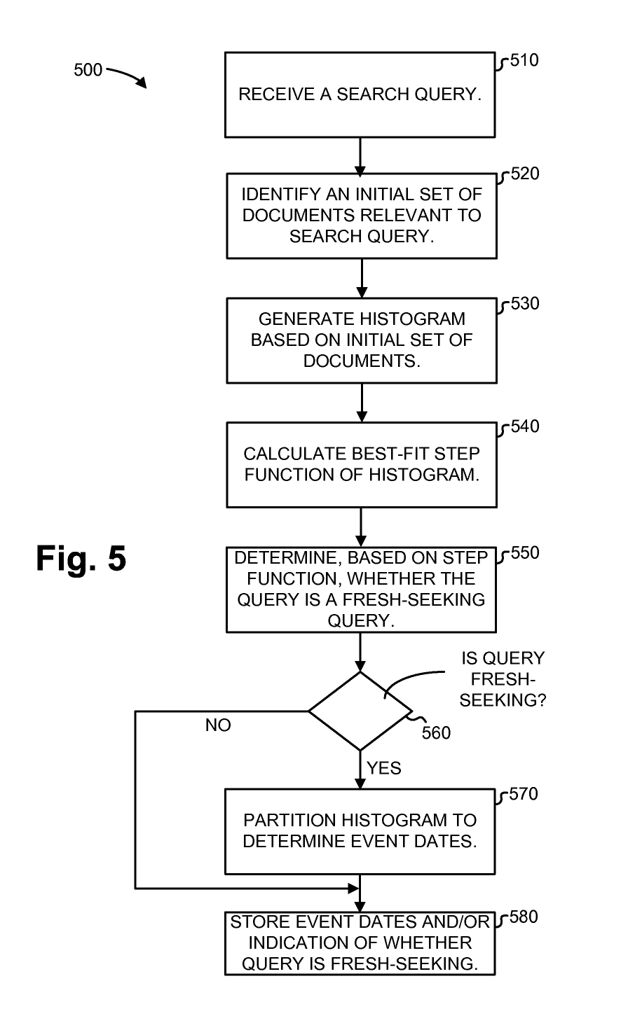

FIG. 5 is a flow chart of an example process 500 for the operation of analysis component 420. Process 500 may be performed by, for example, search server 210 in response to a search query from a client 205. Alternatively, in some implementations, some of process 500 may be performed ahead of time and cached. For example, popular search queries may be processed, and the results stored, ahead of time.

Process 500 may include receiving a search query from a client 205 (block 510). For example, a user of a client 205 may desire to obtain information relating to a particular topic. In one implementation, the search may be an image search in which the user may desire to view images relating to the topic. The user may use a browser program, on a client 205, to input the search query for the image search and transmit the search query to search server 210.

Process 500 may further include identifying an initial set of documents, relevant to the search query (block 520). For instance, search component 410, of search server 210, may query a database or index to identify an initial set of relevant documents (e.g., 1000 documents). Search component 410 may calculate, or otherwise determine, relevance scores associated with the documents. A timestamp, associated with each relevant document, may also be identified by search component 410 or otherwise obtained by analysis component 420. For example, the timestamps may be stored as part of the database or index, or stored in another memory.

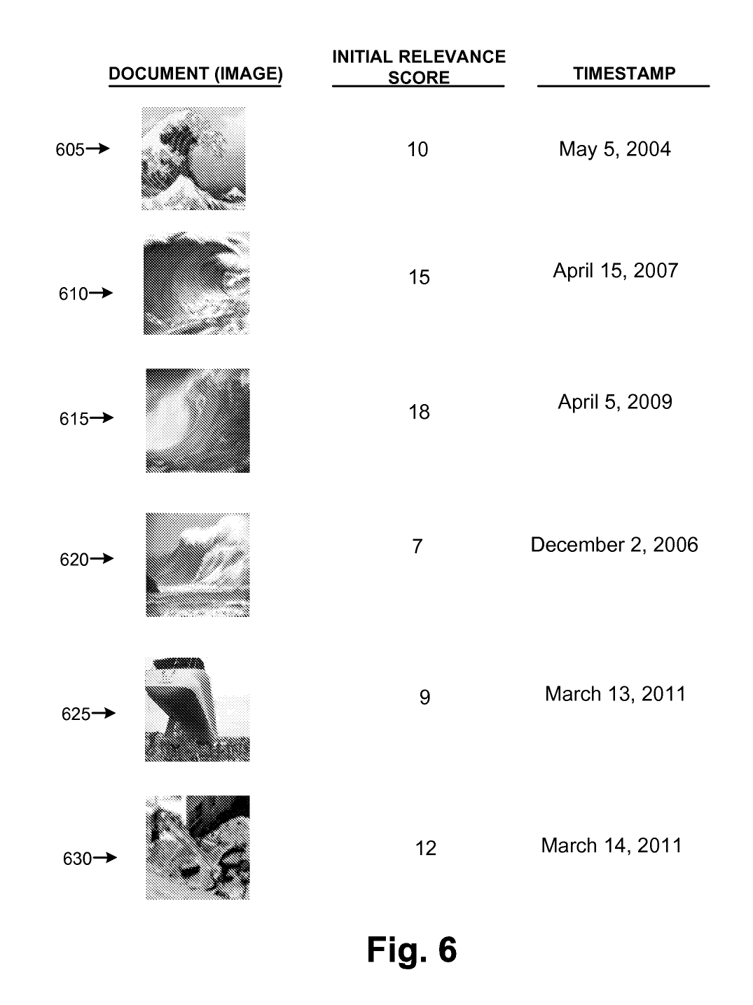

FIG. 6 is a diagram illustrating an example of an initial set of documents. In this example, the search query may be intended for an image search, and the set of documents may include images. As shown, images 605-630 are illustrated. In an actual implementation, the set of documents may include a greater quantity of documents. For each image 605-630, an example initial relevance score and timestamp value are given.

Returning to FIG. 5, process 500 may further include generating a histogram, based on the initial set of documents (block 530). For instance, a histogram may be generated by sorting the timestamps, corresponding to the initial set of documents, and calculating histogram bin values. In one implementation, each bin may correspond to a single day. Alternatively, the bins may correspond to other units of time, such as date periods that span multiple days or a portion of a single day. In one implementation, when aggregating results into a histogram bin, the initial relevance scores may be used to generate the bin values, e.g., the relevance score of a document may represent the “vote” of a document and the vote values of the documents associated with a bin may be summed. By using the relevance scores in calculating the bin values, excessive skew from low relevance documents may be avoided. For example, each bin value may correspond to a sum of the relevance scores (votes) of the documents in the bin. In some implementations, other constraints may be followed when calculating the bin values. For example, in order to limit the effect of very high relevance documents, the vote contributed by each document may be limited, such as by constraining the votes of each document to be no more than the vote of the X^{th} document, where X is an integer (e.g., 20). An appropriate value for X may be selected empirically based on an analysis of example sets of documents. Alternative techniques could be used to generate the bin values. For example, the value of each bin may be set as the quantity of documents in the bin.

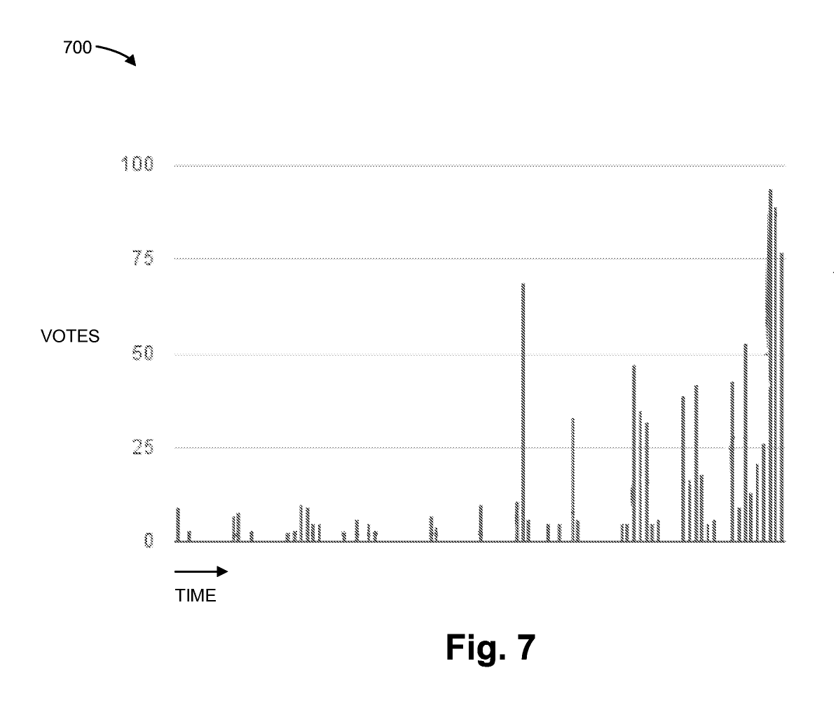

FIG. 7 is a diagram illustrating an example histogram 700, such as a histogram generated in block 530. Assume, for example, that histogram 700 is generated based on an image search query, such as “harry potter.” The horizontal axis may include the bins of the histogram, where each bin represents a single day. The vertical axis may correspond to the total vote value (bin value), e.g., the sum of the relevance scores of the images with timestamps that match a particular day, of the images for any particular day. Not all days may have images, resulting in a zero value for that day.

Referring back to FIG. 5, process 500 may further include calculating a best-fit step function for the histogram (block 540). Qualitatively, a step function may correspond to a timeline in which documents are normally somewhat uniformly generated, but in which an event may cause a temporary or permanent change in the rate of the generation, called the generation rate, of the documents. In one implementation, the step function may be a monotonically increasing step function.

Techniques for fitting a best-fit monotonically increasing step function to a series of values are known. In general, such a technique may include choosing any two adjacent values in the series, and, if the values are not in an increasing order, i.e., an increasing order may be a lower value followed by a higher value, merging the values by replacing them with the average of the values. A weighted average may be used when, due to a previous merging of values, a value represents a number of days. This operation may be repeated until all of the values are in an increasing order. At this point, the final function may be a monotonically increasing best-fit step function. Alternatively, in some implementations, functions other than a monotonically increasing best-fit step function may be fit to the histogram. For instance, the best single-step step function may be used.

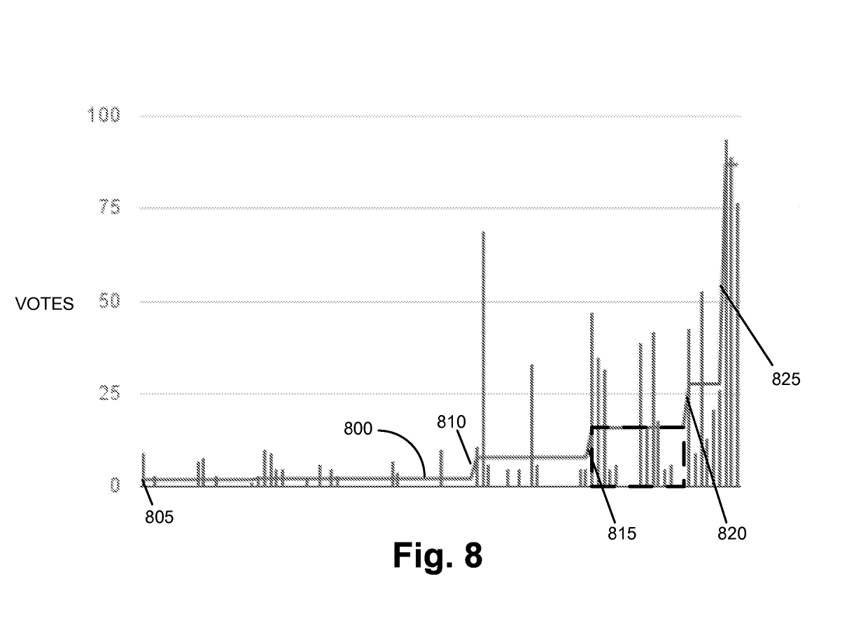

FIG. 8 is a diagram illustrating an example of a monotonically increasing step function 800 generated for histogram 700. Step function 800 includes five steps, steps 805, 810, 815, 820, and 825. These steps 805-825 may correspond to a date at which an event caused an increase in the generation of the number of documents related to the search query. The rectangles defined by each step 805-825 may each correspond to an event epoch. For the image search query “harry potter,” for example, the release of a new movie or book in the Harry Potter series may tend to cause an increase in the generation of images related to the search query “harry potter,” as may potentially be indicated by steps 810, 815, 820, and 825.

Referring back to FIG. 5, process 500 may further include determining, based on step function 800, whether the search query is a fresh-seeking search query (block 550). Whether a search query is a fresh-seeking search query may generally be determined by analysis of the variability of a step function. A step function that is simply a flat line or a step function with very small steps may indicate that no significant event is present in the document timeline. The search query “bear,” for instance, may return a number of images of bears, which may tend to not have any time significance, i.e., an image of a bear from six months ago may be just as likely to be a relevant image as an image from two years ago. A step function with relatively large steps, however, may indicate that at least one event has occurred that may be relevant to the set of documents identified for the search query. In this case, the search query may be deemed to be a fresh-seeking search query.

In one implementation, determining whether a search query is a fresh-seeking search query may be made by comparing the largest step in the best-fit step function to the entire step function or to the previous step in the step function. For instance, the areas formed by the rectangle of each step in the best-fit step function may be calculated. The largest of these areas may then be compared to the total area under the best-fit step function. If the result is greater than a threshold value, e.g., if the largest step area accounts for more than 40% of the area under the step function, the search query may be a fresh-seeking query in which an event, or set of events, may affect the future rate of production of documents. In one implementation, instead of calculating the areas under the steps from zero, the area under each step may be calculated as the area greater than the overall baseline average of the histogram. In other implementations, other techniques may be applied to step function 800 to determine if the steps of step function 800 are variable enough to indicate a fresh-seeking query.

In an alternative possible implementation, instead of using a best-fit step function to determine whether a query is a fresh-seeking query, low pass filtering techniques can be used to identify spikes in the histogram, which may correspond to events.

In yet another alternative possible implementation, when determining the area of a rectangle that corresponds to an epoch that ends at the most recent date in the histogram, the area may be increased, by a factor, to get a value that would be achieved if the rectangle were to extend for an additional quantity (e.g., 5) of days. This may assist in the detection of events soon after the events occur.

In the example of step function 800, assume that the rectangle that begins with step 815, shown as a dashed-line rectangle, is the largest area rectangle. If the area of this rectangle is large, e.g., greater than a threshold, compared to the area under step function 800 or to the area under the rectangle that begins with step 810, step function 800 may be determined as corresponding to a fresh-seeking search query.

If the search query is determined to be a fresh-seeking search query, the histogram may be partitioned to determine event dates (block 560—YES, and block 570). As mentioned above, in one implementation, the partitioning may include dividing the document timeline based on the step of the largest area rectangle in the step function. Dates after this time, in the timeline, may be considered to be within the freshness period of the event while dates before this time may be considered to be pre-event dates, i.e., the date defines the intersection between fresh and stale documents. In another possible implementation, the cutoff date between the fresh and stale documents may be determined as the date when the average value of the histogram crosses the best-fit function. In another alternative implementation, the timeline may be divided into multiple event epochs. For instance, for step function 800, the periods corresponding to steps 815, 820, and 825 may all be considered event epochs. Documents, within these time periods, may have their relevance scores adjusted differently. For example, documents, that are associated with timestamps that are within the epoch of step 825, may have the corresponding relevance scores increased the most, while documents, that are associated with timestamps that are within the epoch step 820, may have the corresponding relevance scores increased, but to a lesser degree than the documents within the epoch of step 825.

Process 500 may further include, either after a determination that a query is not fresh-seeking (block 560—NO) or after block 570, storing an indication of event dates, as potentially determined in block 570, and/or an indication of whether the search query is fresh-seeking (block 580).

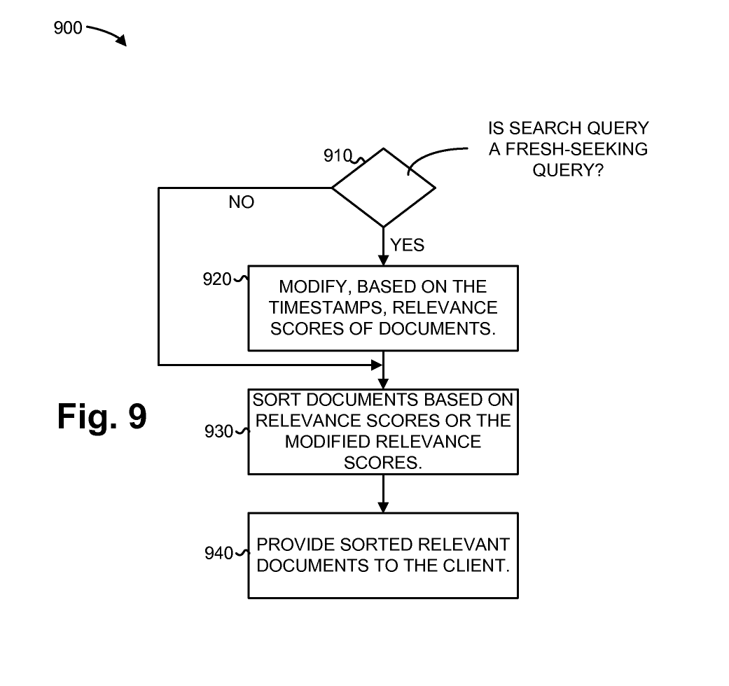

FIG. 9 is a flow chart of an example process 900 illustrating the operation of relevance score modification component 430. Process 900 may be performed by, for example, search server 210 in response to a search query from a client 205. Alternatively, in some implementations, some of process 900 may be performed ahead of time and cached. For example, popular search queries may be processed, and the identified documents stored ahead of time.

Process 900 may include determining whether the search query is fresh-seeking (block 910). Determination of whether a search query is fresh-seeking was discussed previously with reference to block 550.

When the search query is fresh-seeking (block 910—YES), process 900 may include modifying the initial relevance scores, for the set of documents, based on the timestamps (block 920). In one implementation, as previously discussed, the timeline of documents for a fresh-seeking query may be divided based on a single date that defines the beginning of an event. Documents associated with dates before this date may have their relevance scores decreased, or alternatively, documents associated with dates after this date may have their relevance scores increased. As an example, the older documents may have their relevance scores decreased by a factor corresponding to the ratio between an average document production rate over the histogram, i.e., the average value of the histogram, or over a particular time period, e.g., the average of the last year, and the average of the epoch in the histogram corresponding to the date that defines the beginning of the event.

In alternative implementations, other techniques may be used to modify the relevance scores. For example, each relevance score may be modified by a factor corresponding to the epoch associated with the relevance score, i.e., a modification factor may be calculated for each epoch and applied to all documents with timestamps in that epoch. As another example, instead of modifying relevance scores, the sorted position of the initial set of documents may be modified. For instance, documents is a recent epoch may be boosted a certain quantity of positions in the sorted list of relevant documents.

When the search query is not a fresh-seeking query (block 910—NO), the relevance scores may not be modified and the documents may thus be ranked based on the original relevance scores, such as those obtained from search component 410.

Process 900 may further include sorting the initial set of documents based on the modified relevance scores, or the original relevance scores if the search query is not a fresh-seeking search query (block 930). By sorting the initial set of documents, the most relevant documents may be at the top of the list of documents.

Process 900 may further include providing the sorted relevant documents to client 205 (block 940). In one implementation, a limited quantity of documents may be returned to client 205. For example, the top 50 documents may be provided to client 205.

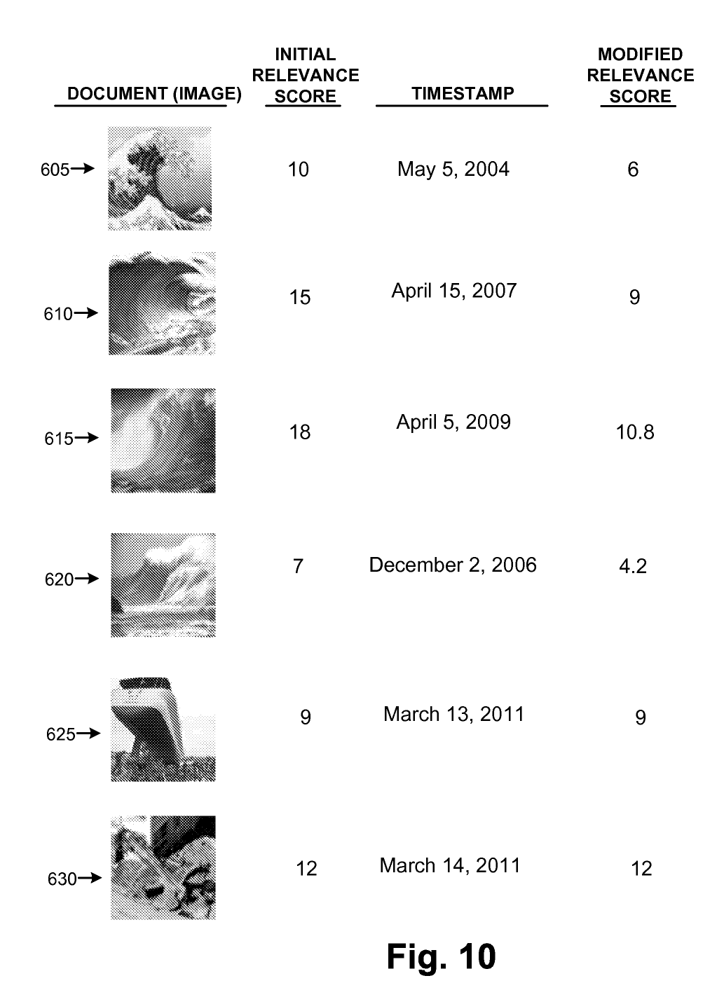

FIG. 10 is a diagram illustrating an example of the set of documents, as shown in FIG. 6, and further including an example of the modified versions of the relevance scores. As in FIG. 6, in this example, the search query may be an image search and the set of documents may include images. Images 605-630 are illustrated. For each image 605-630, an initial relevance score, a timestamp value, and a modified relevance score are given. Assume that for this search query, the search query is determined to be fresh-seeking, and the freshness cutoff date is determined so that images 625 and 630 are fresh images and images 605-620 are stale images. For example, the cutoff date may be determined to be Mar. 11, 2011. Further, assume that, based on the best-fit step function corresponding to this search query, a modification factor of 0.6 is determined and applied to the relevance scores of each of the stale images (images 605-620). After modification, image 630 may now have the highest relevance score and may thus be returned, to the user, as the most relevant image. The next most relevant images are illustrated as image 615 and then image 625.

Techniques were described herein to identify fresh-seeking search queries and to modify relevance scores of the results of the fresh-seeking search queries. Although particularly discussed in terms of images, other types of documents, such as text documents, may instead be used. Still further, the techniques discussed above may be applied to other fields, such as financial times series, events on newswires, short messaging posts, email traffic, advertising rates, etc. In general, the techniques described herein can be used to determine the appearance of new information or new concepts, and the relative importance of the new information/concepts.

The foregoing description provides illustration and description, but is not intended to be exhaustive or to limit the embodiments to the precise form disclosed. Modifications and variations are possible in light of the above teachings or may be acquired from practice of these embodiments.

For example, while a series of blocks have been described with regard to FIGS. 5 and 9, the order of the blocks may be modified in other implementations. Further, non-dependent blocks may be performed in parallel. In addition, other blocks may be provided, or blocks may be eliminated, from the described flowcharts, and other components may be added to, or removed from, the described systems.

It will be apparent that aspects described herein may be implemented in many different forms of software, firmware, and hardware in the implementations illustrated in the figures. The actual software code or specialized control hardware used to implement aspects does not limit the embodiments. Thus, the operation and behavior of the aspects were described without reference to the specific software code—it being understood that software and control hardware can be designed to implement the aspects based on the description herein.

It should be emphasized that the term “comprises/comprising,” when used in this specification, is taken to specify the presence of stated features, integers, steps, or components, but does not preclude the presence or addition of one or more other features, integers, steps, components, or groups thereof.

Even though particular combinations of features are recited in the claims and/or disclosed in the specification, these combinations are not intended to limit the disclosure of the implementations. In fact, many of these features may be combined in ways not specifically recited in the claims and/or disclosed in the specification. Although each dependent claim listed below may directly depend on only one other claim, the disclosure of the implementation includes each dependent claim in combination with every other claim in the claim set.

No element, act, or instruction used in the present application should be construed as critical or essential to the disclosed embodiments unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

1. A method performed by one or more server devices, the method comprising:
receiving, by at least one of the one or more server devices and from a client, a search query;
identifying, by at least one of the one or more server devices, a plurality of documents relevant to the search query,
where each of the plurality of documents is associated with a timestamp and a relevance score;
sorting, by at least one of the one or more server devices, the plurality of documents, based on the timestamps, to create a timeline of documents;
determining, by at least one of the one or more server devices, a best-fit step function to fit the timeline of documents,
the best-fit step function being determined by averaging a plurality of values associated with the timeline of documents, and
the best-fit step function including a plurality of values,
each value, of the plurality of values included in the best-fit step function, corresponding to a respective date associated with an increase in a quantity of documents, of the plurality of documents, that are relevant to the search query;
identifying, by at least one of the one or more server devices, at least one event, associated with the timeline of documents, based on the best-fit step function;
determining, by at least one of the one or more server devices and based on the at least one event, a type of query associated with the search query,
determining the type of query including:
comparing information associated with a particular value, of the plurality of values included in the best-fit step function, to information associated with at least one other value of the plurality of values included in the best-fit step function; and
determining, when the comparison of the information associated with the particular value and the information associated with the at least one other value satisfies a threshold, the type of query;
modifying, by at least one of the one or more server devices and based on the determined type of query and the at least one event, the relevance scores of the plurality of documents; and
transmitting, by at least one of the one or more server devices, information associated with a portion of the plurality of documents, based on the modified relevance scores, to the client.

2. The method of claim 1, where the plurality of documents include a plurality of images.

3. The method of claim 1, where sorting the plurality of documents includes arranging the plurality of documents into a histogram.

4. The method of claim 3, where determining the best-fit step function includes fitting the best-fit step function to the histogram.

5. The method of claim 1, where
when determining the type of query, the method includes:
determining whether the search query is a fresh-seeking search query based on a variability of the best-fit step function, and
when modifying the relevance scores, the method includes:
modifying the relevance scores when the search query is determined to be a fresh-seeking search query.

6. The method of claim 1, where modifying the relevance scores includes:
decreasing the relevance scores that correspond to the plurality of documents with timestamps that are associated with dates before occurrence of the at least one event.

7. The method of claim 1, where modifying the relevance scores includes:
increasing the relevance scores that correspond to the plurality of documents with timestamps that are associated with dates after occurrence of the at least one event.

8. The method of claim 1, where modifying the relevance scores includes:
multiplying the relevance scores, of the plurality of documents, by a factor determined by the at least one event.

9. The method of claim 1, where the best-fit step function includes a monotonically increasing step function.

10. The method of claim 1, where the best-fit step function includes a single-step best-fit step function.

11. A non-transitory computer-readable medium storing instructions, the instructions comprising:
one or more instructions, which when executed by one or more processors, cause the one or more processors to receive, from a client, a search query;
one or more instructions, which when executed by the one or more processors, cause the one or more processors to identify a plurality of documents relevant to the search query,
where each of the plurality of documents is associated with a timestamp and a relevance score;
one or more instructions, which when executed by the one or more processors, cause the one or more processors to sort the plurality of documents, based on the timestamps, to create a timeline of documents;
one or more instructions, which when executed by the one or more processors, cause the one or more processors to determine a best-fit step function to fit the timeline of documents,
the best-fit step function being determined by averaging a plurality of values associated with the timeline of documents, and
the best-fit step function including a plurality of values,
each value, of the plurality of values included in the best-fit step function, corresponding to a respective date associated with an increase in a quantity of documents, of the plurality of documents, that are relevant to the search query;
one or more instructions, which when executed by the one or more processors, cause the one or more processors to identify at least one event, associated with the timeline of documents, based on the best-fit step function;
one or more instructions, which when executed by the one or more processors, cause the one or more processors to determine, based on the at least one event, a type of query associated with the search query,
the one or more instructions to determine the type of query including:
one or more instructions to compare information associated with a particular value, of the plurality of values included in the best-fit step function, to information associated with at least one other value of the plurality of values included in the best-fit step function; and
one or more instructions to determine, when the comparison of the information associated with the particular value and the information associated with the at least one other value satisfies a threshold, the type of query;
one or more instructions, which when executed by the one or more processors, cause the one or more processors to modify, based on the determined type of query and the at least one event, the relevance scores of the plurality of documents; and
one or more instructions, which when executed by the one or more processors, cause the one or more processors to transmit information associated with one or more of the plurality of documents, based on the modified relevance scores, to the client.

12. A computing device comprising:
a memory to store instructions; and
one or more processors, to execute the instructions, to:
receive, from a client, a search query;
identify a plurality of documents, relevant to the search query,
where each of the plurality of documents is associated with a timestamp and a relevance score;
sort the plurality of documents, based on the timestamps, to create a timeline of documents;
determine a best-fit step function to fit the timeline of documents,
the best-fit step function being determined by averaging a plurality of values associated with the timeline of documents, and
the best-fit step function including a plurality of values,
each value, of the plurality of values included in the best-fit step function, corresponding to a respective date associated with an increase in a quantity of documents, of the plurality of documents, that are relevant to the search query;
identify at least one event, associated with the timeline of documents, based on the best-fit step function;
determine, based on the at least one event, a type of query associated with the search query,
the one or more processors, when determining the type of query, being further to:
compare information associated with a particular value, of the plurality of values included in the best-fit step function, to information associated with at least one other value of the plurality of values included in the best-fit step function; and
determine, when the comparison of the information associated with the particular value and the information associated with the at least one other value satisfies a threshold, the type of query;
modify, based on the determined type of query and the at least one event, the relevance scores of the plurality of documents; and
transmit information associated with a set of the plurality of documents, based on the modified relevance scores, to the client.

13. The computing device of claim 12, where the plurality of documents include a plurality of images.

14. The computing device of claim 12, where the one or more processors are further to:
arrange the plurality of documents into a histogram.

15. The computing device of claim 14, where the one or more processors, when determining the best-fit step function, are further to:
fit the best-fit step function to the histogram.

16. The computing device of claim 12, where
the one or more processors, when determining the type of query, are further to:
determine whether the search query is a fresh-seeking search query based on a variability of the best-fit step function, and
the one or more processors, when modifying the relevance scores, are further to:
modify the relevance scores when the search query is determined to be a fresh-seeking search query.

17. The computing device of claim 12, where the one or more processors, when modifying the relevance scores, are further to:
decrease the relevance scores that correspond to the plurality of documents with timestamps that are associated with dates before the at least one event.

18. The computing device of claim 12, where the one or more processors, when modifying the relevance scores, are further to:
increase the relevance scores that correspond to the plurality of documents with timestamps that are associated with dates after the at least one event.

19. The computing device of claim 12, where the one or more processors, when modifying the relevance scores, are further to:
multiply the relevance scores, of the plurality of documents, by a factor determined by the at least one event.

20. The computing device of claim 12, where the best-fit step function includes a monotonically increasing step function.
